(19) United States
(12) Patent Application Publication
(10) Pub. No.: US 2009/0053943 A1
(43) Pub. Date: Feb. 26, 2009

(54) Bringing a cable into contact with a flexible strip conductor

(75) Inventors: Martin Fink, Nurnberg (DE); Christian Janisch, Burglengenfeld (DE); Karl Smirra, Wasserburg (DE)

Correspondence Address: LERNER GREENBERG STEMER LLP, P O BOX 2480, HOLLYWOOD, FL, 33022-2480, US

(73) Assignee: Siemens Aktiengesellschaft, Munchen (DE)

(21) Appl. No.: 11/665,661

(22) PCT Filed: Sep. 30, 2005
(86) PCT No.: PCT/EP2005/054940

§ 371 Date: Apr. 18, 2007

(30) Foreign Application Priority Data
Oct. 18, 2004 (DE) 10 2004 050 687.6

(51) Int. Cl. H01R 4/02

(52) U.S. Cl. 439/876

(57) ABSTRACT

The invention relates to a cable for bringing into contact with a contact point of a flexible strip conductor, to a contact strip for one or more cables of this type, and to a system for bringing control electronics, which are situated on a flexible printed circuit board, into contact with at least one electrical and/or electronic component. The component is, particularly, a mechatronic transmission or engine controller of a motor vehicle. A special contact with a welding boss is placed at the end of a cable. A bundle of cables of this type is fixed in a defined position by way of a contact strip. The invention enables, for the first time, one or more cables to be directly brought into contact with the contact point(s) of a flexible strip conductor. This advantageously eliminates additional contact points and parts such as mating connectors, etc. whereby leading to a distinct improvement in quality and reduction in costs. The invention is particularly suited for use in contacting systems in mechatronic transmission or engine controllers, etc. of a motor vehicle.

Bringing a cable into contact with a flexible strip conductor

The present invention relates to a cable for bringing into contact with a contact point of a flexible printed circuit board; a contact strip for one or more cables of this type and a system for bringing an electronic control system, which is positioned on a flexible printed circuit board, into contact with at least one electrical and/or electronic component, in particular for mechatronic transmission or engine controllers in a motor vehicle.

Automatic transmissions for automobiles and also internal combustion engines and braking systems, etc. tend increasingly to be predominantly controlled by electronic means. While until now what are known as stand-alone control devices were provided for mounting in an electronics chamber (e-box) providing protection against environmental influences or in the passenger space, the trend now is for what are known as mechatronic controllers, in other words for integrating electronic control systems and the associated sensors in the transmission, engine, braking system, etc. There are similar trends for “local electronic systems” in other areas outside automotive engineering too, for example in aerospace engineering, marine engineering, etc.

In some applications using mechatronic controllers stamped grids are used for power and signal distribution. However this solution has clear disadvantages with regard to the sealing of the electronics chamber, protection against chips, flexibility and tolerance compensation. Also compliance with minimum cross-sections of the stamped grids means that it is more difficult to deconcentrate the strip conductors than is the case with flex strip conductors (configuration of very fine structures of Cu strip conductors) or cable harnesses. When changes have to be made, expensive modifications also have to be made to the stamping tool.

It is also known that a number of conducting cables can be provided, which operate together as a cable harness, to transmit signals and currents between an electronic control system and various electrical and/or electronic components (in particular sensors, valves, etc.).

In order to be able to bring the conducting cable into contact with a flexible printed circuit board FPCB, on which the electronic control system is positioned, the cable ends are generally provided with crimp contacts, which are then mounted in a plug connector (molded or plugged in). The matching counter-contacts are mounted in an associated mating connector. The contact feet of the mating connector are brought into contact with the FPCB (by plugging in, soldering, welding, etc.).

A plug system of this type comprises a number of contact points and individual parts. For reasons of quality and finance a solution is sought, which allows a more direct route for the connection, in particular when a detachable connecting method is not required.

With this in mind, the object of the present invention is to bring a cable into contact in an improved, in particular a more direct, manner with a flexible printed circuit board (FPCB).

According to the invention this object is achieved by the features of the independent claims. Advantageous embodiments and developments, which can be used individually or in combination with each other, are the subject matter of the dependent claims.

According to the invention a special contact with a welding boss is disposed at the cable end of the cable to bring it into contact with a contact point of a flexible printed circuit board (FPCB). Such a contact has the advantage that it is not plugged into a counter-part—as it usually is in the prior art—but can be welded directly to the contact point of the flexible printed circuit board by means of the welding boss.

The inventive contact is preferably fixed to the cable end by crimping.

The reliability of the contact can be increased, if the inventive contact is fixed to the cable end by soldering, as an alternative or in addition to crimping.

The inventive contact can finally also be configured as what is known as a plastic-metal hybrid part using a 2K injection molding method. This plastic-metal hybrid part can then be brought into contact with the FPCB.

In order to be able also to bring a number of cables with an inventive contact into reliable contact with a flexible printed circuit board (FPCB), the present invention also relates to a contact strip, which fixes the contacts in a defined position.

In the simplest embodiment defined slots are preferably configured in the contact strip for this purpose for each contact.

Alternatively or in addition the contacts are preferably embedded in the contact strip by means of a plastic injection method.

As already optional with the inventive contact, it has also proven advantageous with the inventive contact strip to configure this as what is known as a plastic-metal hybrid part.

The subject matter of the invention is finally also a system for bringing an electronic control system positioned on a flexible printed circuit board into contact with at least one electrical and/or electronic component, in particular for mechatronic transmission or engine controllers in a motor vehicle, comprising a cable of the type mentioned above and/or a contact strip of the type mentioned above, which is brought into contact with the contact point(s) of a flexible printed circuit board by means of a welding process.

The present invention first of all allows one or more cables to be brought into contact directly with the contact point(s) of a flexible printed circuit board. This means there is advantageously no need for additional contact points and individual parts such as mating connectors, etc., resulting in a distinct improvement in quality and a reduction of costs.

Inventive contacts are suitable for all contacting between a cable and a flexible printed circuit board or vice versa, in particular for mechatronic transmission or engine controllers in a motor vehicle.

Additional details and further advantages of the invention are described below with reference to a preferred exemplary embodiment in conjunction with the accompanying drawing, in which:

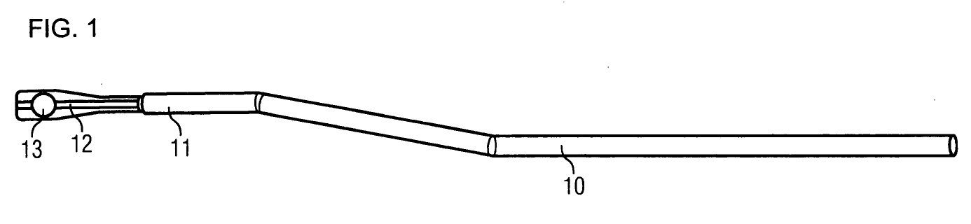

FIG. 1 shows a schematic diagram of a view from below of a cable with a special contact disposed at the cable end;

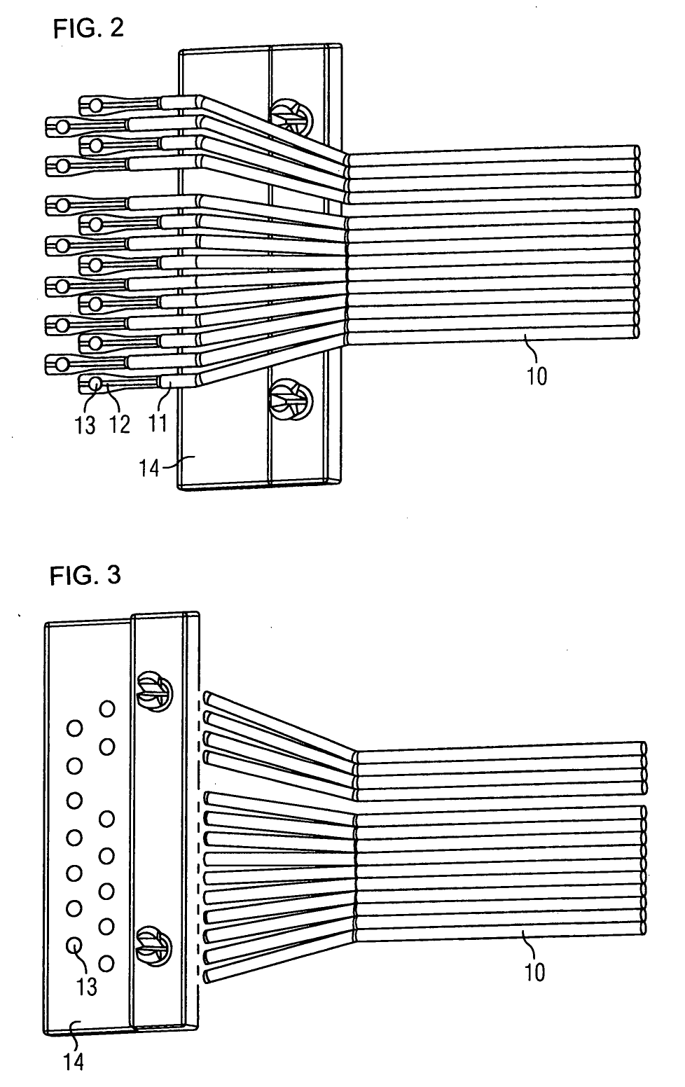

FIG. 2 shows a schematic diagram of a view from below of a bundle of cables according to FIG. 1;

FIG. 3 shows a schematic diagram of a view from below of the bundle of cables according to FIG. 2 fixed in a contact strip;

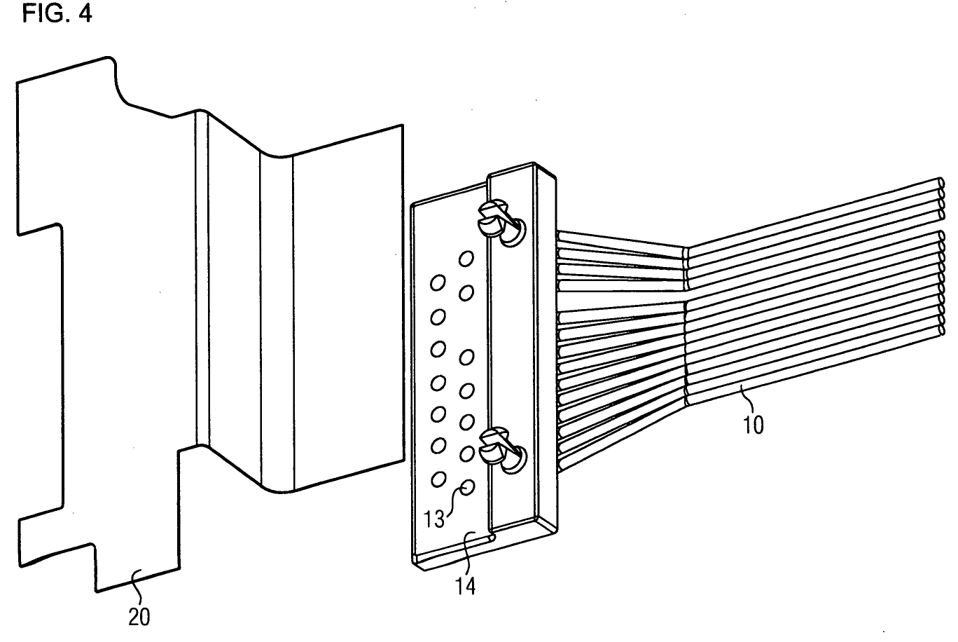

FIG. 4 shows a schematic diagram of a perspective view from below of the contact strip according to FIG. 3 before being brought into contact with a flexible printed circuit board;

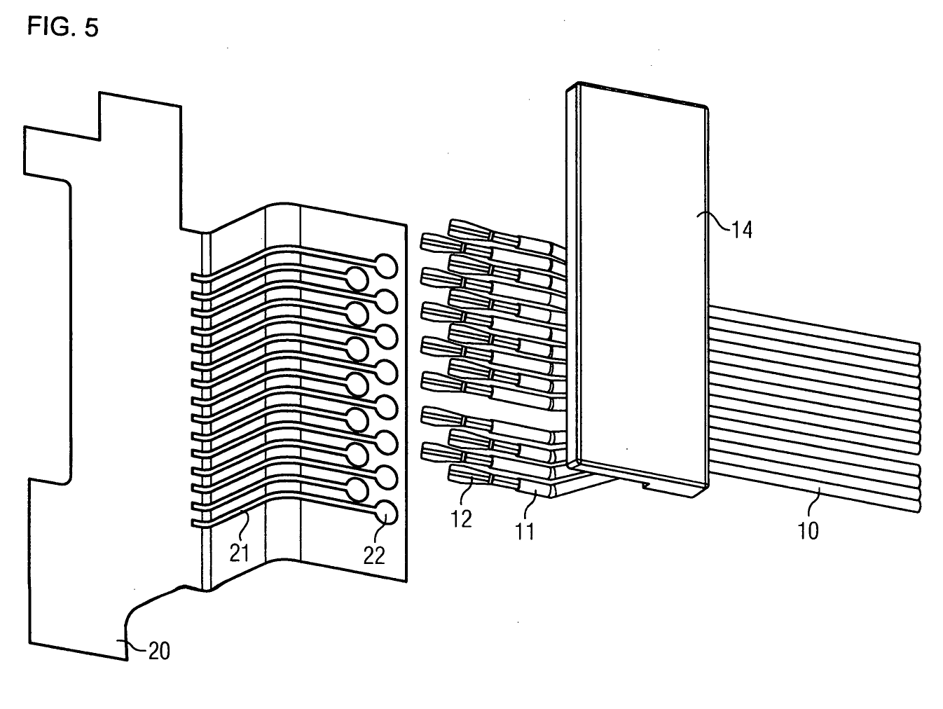

FIG. 5 shows a schematic diagram of a perspective top view of the bundle of cables according to FIG. 2 before being fixed in the contact strip and being brought into contact with a flexible printed circuit board;

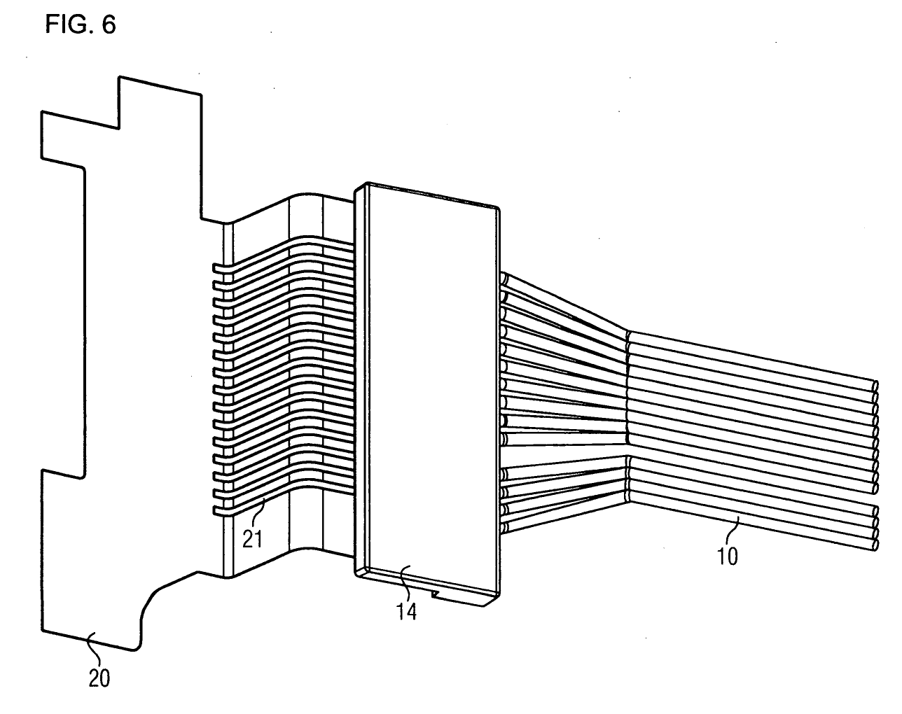

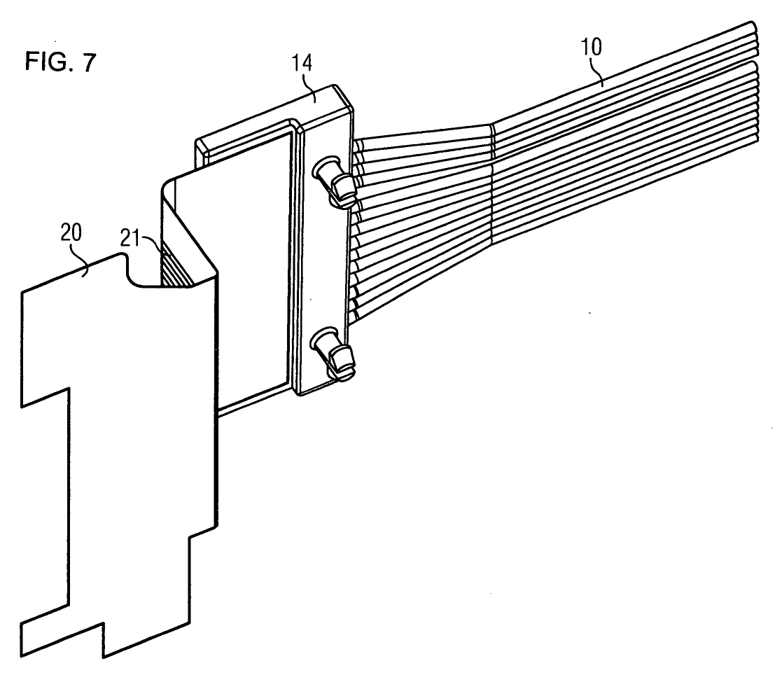

FIG. 6 shows a schematic diagram of a perspective top view of the diagram according to FIG. 5 after fixing and contacting; and

FIG. 7 shows a schematic diagram of the perspective view from below of the diagram according to FIG. 6.

In the description which follows of the preferred embodiments of the present invention identical reference characters identify identical or comparable components.

FIG. 1 shows a view from below of a cable 10, which is provided with a special contact 12 at its end 11. The special contact 12 can be squeezed and/or soldered to the copper of the cable 10 using a crimping tool. The contact region 12, 13 is configured in such a manner that it can be brought into contact directly with the contact point 22 of a flexible printed circuit board (FPCB) 20 by means of a welding process (see FIG. 5 for details. A welding boss 13 is configured in particular on the contact 12 for this purpose. The welding boss 13 can be configured for example by means of deep drawing process, by applying material and/or by means of another suitable molding or, respectively, welding/soldering process. In particular the contact 12 and welding boss 13 can also be configured as what is known as a plastic-metal hybrid part.

FIG. 2 shows a view from below of an unfixed bundle of cables 10 according to FIG. 1 above a contact strip 14.

FIG. 3 shows a view from below of the bundle of cables 10 according to FIG. 2, here however fixed in the contact strip 14. It shows clearly how the contact strip 14 fixes the welding bosses 13 in a defined position. Fixing can take place by way of slots (not shown) configured in the contact strip 14 and/or by means of a plastic injection method, which preferably embeds the contacts 12, in such a manner that only the contact bosses 13 are exposed. Alternatively the contact strip 14 can also be configured as a plastic-metal hybrid part.

FIG. 4 shows a perspective view from below of the contact strip 14 according to FIG. 3 with the welding bosses 13 embedded therein before they are brought into contact with a flexible printed circuit board 20.

FIG. 5 shows a perspective top view of the bundle of cables 10 according to FIG. 2 before they are fixed in the contact strip 14 and brought into contact with a flexible printed circuit board 20. It shows clearly how contact points 22 are provided at the end of the strip conductors 21 for reliable contacting.

Finally FIG. 6 shows a perspective top view of the diagram according to FIG. 5 after fixing by means of the contact strip 14 and bringing into contact as part of a welding process; FIG. 7 shows the diagram in FIG. 6 in a perspective view from below. Such a contacting system is particularly suitable for bringing an electronic control system (not shown) positioned on a flexible printed circuit board 20 into contact with at least one electrical and/or electronic component (also not shown), as found in particular in mechatronic transmissions in modern motor vehicles. A number of conducting cables 10, which transmit sensor signals and valve flows, must be brought into contact here in the known manner with a flexible printed circuit board 20, on which the electronic control system is positioned. The same applies to modern engine controllers.

The present invention first of all allows one or more cables 10 to be brought into contact directly with the contact point(s) 22 of a flexible printed circuit board 20. This means there is advantageously no need for additional contact points and individual parts, such as mating connectors, etc., resulting in a distinct improvement in quality and a reduction of costs.

The inventive contacting is suitable for all contacting between a cable 10 and a flexible printed circuit board 20 or vice versa, in particular for contacting systems in mechatronic transmission or engine controllers in a motor vehicle.

1-8. (canceled)

9. A cable for contacting a contact point of a flexible printed circuit board, comprising a contact at a cable end of the cable, and a welding boss disposed at said contact at the cable end.

10. The cable according to claim 9, wherein said contact is fixed to said cable end by way of crimping and/or soldering.

11. The cable according to claim 9, wherein said contact is a plastic-metal hybrid part.

12. A contact strip for one or a plurality of cables according to claim 9, said contact strip being configured to fix said contacts in a defined position.

13. The contact strip according to claim 12, having slots formed therein for each said contact.

14. The contact strip according to claim 12, wherein said contacts are embedded in the contact strip by way of plastic injection molding.

15. The contact strip according to claim 12, wherein said contact strip is a plastic-metal hybrid part.

16. A system for connecting an electronic control system positioned on a flexible printed circuit board with at least one electrical and/or electronic component, the system comprising:
at least one cable formed with a cable end, a contact at said cable end, and a welding boss at said contact for connection to a contact point on the printed circuit board;
a contact strip for said at least one cable configured to fix said contact;
wherein said contact and said welding boss are brought into contact with the contact point on the flexible printed circuit board by welding.

17. The system according to claim 16 configured for contacting a mechatronic transmission or engine controller in a motor vehicle.

18. The system according to claim 16, wherein said at least one cable is one of a plurality of cables each having a respective cable end with a contact and a welding boss, and said contact strip is formed with a plurality of defined locations for fixing said contacts of said cables.
